(19) United States
(12) Patent Application Publication
(10) Pub. No.: US 2011/0186503 A1
(43) Pub. Date: Aug. 4, 2011

(54) DEVICE FOR PROCESSING A COOLING AND FLUSHING LIQUID

(75) Inventors: Georg HOLZMEIER, Untermeitingen (DE); Marc Schuster, Karlsruhe (DE); Andreas Burkhard, Schwabmuenchen (DE)

(73) Assignee: Hilti Aktiengesellschaft, Schaan (LI)

(21) Appl. No.: 12/972,252

(22) Filed: Dec. 17, 2010

(30) Foreign Application Priority Data
Dec. 18, 2009 (DE) 10 2009 055 011.9

(51) Int. Cl. B01D 35/02

(52) U.S. Cl. 210/435

(57) ABSTRACT

A device for processing a cooling and flushing liquid from a dirty liquid is disclosed. The device includes a first container, which cooperates with a suction device for the dirty liquid and collects the suctioned dirty liquid, a second container, which cooperates with an overpressure device, and a filter element, which is arranged in the second container. The filter element is arranged in a direction of flow before the second container.

This application claims the priority of German Patent Document No. 10 2009 055 011.9, filed Dec. 18, 2009, the disclosure of which is expressly incorporated by reference herein.

### BACKGROUND AND SUMMARY OF THE INVENTION

The present invention relates to a device for processing a cooling and flushing liquid.

When using abrasive machining with diamond tools, for example in the form of diamond core bits or diamond saws, it is necessary to cool the diamond tool in the region of the machining location in order to avoid damaging the diamond tool from overheating. The cutting segments of the diamond tool are cooled during the machine operation by a cooling liquid in order to support the machine operation and to increase the service life of the cutting segments. The liquid also serves to remove the solid matter removed by the diamond tool from the machining location. The liquid supplied is called cooling and flushing liquid and the liquid containing solid matter is called the dirty liquid.

European Patent Document No. EP 0 941 828 B1 discloses a known processing device for processing a cooling and flushing liquid from a dirty liquid and for conveying the recycled cooling and flushing liquid to a power tool, for example a core drill. The processing device includes two containers that are sealed air-tight and liquid-tight. During operation, the first container is configured as a vacuum container by a vacuum device and the second container is configured as an overpressure container by an overpressure device. The vacuum container is connected via a connecting line to the overpressure container. With the aid of the vacuum device, the dirty liquid is suctioned via a supply line into the vacuum container, which is also used for pre-cleaning the dirty liquid. The overpressure device, which is arranged in the connecting line, conveys the pre-cleaned dirty liquid out of the vacuum container via the connecting line into the overpressure container. Situated on the cover of the overpressure container is a filter element, which is in contact with the pre-cleaned dirty liquid on an outer side. Due to the overpressure, the pre-cleaned dirty liquid flows into the interior of the filter element. Any solid matter present in the pre-cleaned dirty liquid gets caught in the filter element. Recycled cooling and flushing liquid collects in the interior of the filter element, which can be conveyed to the power tool. Because of the overpressure, the recycled cooling and flushing liquid flows via a supply line to a power tool.

Operation of the known processing device provides that prior to every longer work break and at the end of a work day, the containers must be cleaned and the filter element must be regenerated. For reasons of durability, the filter element is configured as a ceramic body and is sanded with a cleaning pad under flowing water until the ceramic body appears. This regeneration procedure is repeated until the minimum wall thickness of the ceramic body has been reached.

The disadvantage of the known processing device is that when cleaning and regenerating the ceramic filter, the operator comes into contact with the solid matter of the dirty liquid and the recycled cooling and flushing liquid, which can cause irritations to the operator.

In contrast, the object of the present invention is further developing the known processing device to the effect that the operator's contact with the solid matter in the dirty liquid and recycled cooling and flushing liquid is reduced.

A device for processing a cooling and flushing liquid from a dirty liquid having a first container, which cooperates with a suction device for the dirty liquid and collects the suctioned dirty liquid, a second container, which cooperates with an overpressure device, and a filter element, which is arranged in the second container, is provided.

According to the invention, the filter element is arranged in a direction of flow before the second container. Particularly preferably a connecting line is provided, which connects the first container to the filter element. The dirty liquid containing solid matter is conveyed via the connecting line to the filter element. The solid matter gets caught in the filter element so that a majority of the solid matter is located in the interior space of the filter element.

In a preferred embodiment, the filter element is configured cylindrically with a base, a lateral area, and a cover, wherein at least one filter surface is provided in the lateral area. It is particularly preferred that the cover is captively connected to the lateral area. The operator does not come into contact with solid matter that is located in the interior space of the filter element due to the fact that the interior space of the filter element is not accessible to the operator.

In a preferred embodiment, the filter element is configured as a one-piece injection molded part, which was insert molded around the filter surface. This type of manufacturing is cost-effective and therefore suited above all for filter elements that are being used as a disposable resource that are disposed of after use.

In a preferred embodiment, the filter element is mechanically supported on the second container by a holding device. In this case, the holding device is particularly preferably configured as a support element, which is connected to the second container. The holding device makes sure that the filter element is mechanically stable and does not get deformed from the overpressure of the overpressure device.

Additional advantages and advantageous embodiments of the subject of the invention can be found in the description and the drawings. Likewise, the features cited in the foregoing as well as those mentioned below may be used according to the invention individually or in a multiple manner in any combination. The depicted and described embodiments are not to be understood as an exhaustive listing, rather they have an exemplary nature for the description of the invention.

### BRIEF DESCRIPTION OF THE DRAWINGS

FIG. 1 illustrates a core drill with a processing device according to the invention for processing a cooling and flushing liquid from a dirty liquid having a filter element, which is arranged before the second container; and

FIG. 2 illustrates an embodiment of the filter element of the processing device according to the invention depicted in FIG. 1.

### DETAILED DESCRIPTION OF THE DRAWINGS

Unless otherwise stated, the same or functionally equivalent elements are indicated in the figures with the same reference numbers.

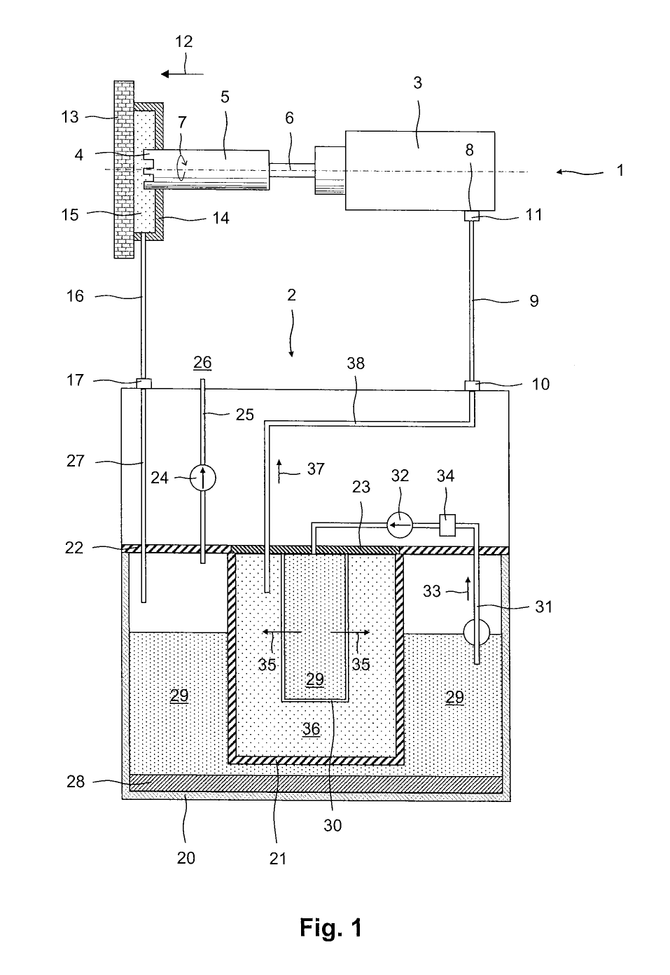

The power tool depicted in FIG. 1 is configured as a core drill 1 and connected to an inventive processing device 2 for processing a cooling and flushing liquid.

The core drill 1 includes a machine unit 3, which drives core bit 5 equipped with cutting segments 4 around an axis of rotation 6 in a rotational direction 7. The cooling and flushing liquid is conveyed via an inlet opening 8 of the machine unit 3. The inlet opening 8 is connected via a supply line 9 to an outlet port 10 of the processing device 2. Alternatively, the cooling and flushing liquid may be conveyed to a suction or flushing head, which is arranged in the direction of flow behind the machine unit 3.

The flow of the cooling and flushing liquid into the machine unit 3 is adjustable via a regulating device 11, which is connected to the inlet opening 8 of the machine unit 3 and which is manually operated by an operator. In this case, the regulating device 11 is configured as a shut-off device and is adjustable between an open position, in which the cooling and flushing liquid may flow into the machine unit 3, and a closed position, in which the inflow of the cooling and flushing liquid to the machine unit 3 is interrupted. Alternatively, the regulating device 11 may facilitate a discrete or continuous adjustment of the flow of the cooling and flushing liquid between 0% (closed position) and 100% (open position).

During a drilling operation, i.e., while the core bit 5 is being driven around the axis of rotation 6 and the cutting segments 4 are penetrating a substrate 13 being processed in a drilling direction 12, the core bit 5 is flushed by the cooling and flushing liquid and cooled in the region of the processing location. A collecting device 14 is arranged on the substrate 13 being processed enclosing the processing location and collecting a cooling and flushing liquid that has been heated up and contains solid matter, which is designated as the dirty liquid 15. The collecting device 14 is attached via a suction line 16 to an inlet port 17 of the processing device 2.

The processing device 2 includes a first and second container 20, 21. In order to configure the processing device 2 as compactly as possible, the second container 21 is arranged in the first container 20 and both containers 20, 21 are respectively sealed air-tight and liquid-tight via a cover 22, 23. Alternatively the two containers 20, 21 may be arranged side by side.

The first container 20 cooperates during drilling operation with a suction device 24, which conveys the dirty liquid 15 from the collecting device 14 to the first container 20. The suction device 24 is configured for example as a device for generating a vacuum and is designated as a vacuum device in the following; the first container 20 is also designated as a vacuum container. The vacuum device 24 is arranged in a suction line 25, which opens on one end in the vacuum container 20 and opens on another end to an atmosphere 26. As a result of the vacuum that prevails in the vacuum container 20 in relation to the collecting device 14, the dirty liquid 15 is conveyed to the vacuum container 20 via the suction line 16 and a feed line 27, which is connected on one end to the inlet port 17 of the processing device 2 and discharges with another end into the vacuum container 20.

In addition, the vacuum container 20 is used to pre-clean the dirty liquid 15. Because of gravity, the solid matter, which is present in the dirty liquid 15 because of the material removed from the substrate 13, gets deposited on the base of the vacuum container 20 as solid matter sedimentation 28. A pre-cleaned dirty liquid 29 is located above the deposited solid matter 28.

Arranged in the second container 21 is a filter element 30, which is connected to the vacuum container 20 via a connecting line 31. So that the solid matter 28 that has already been deposited because of gravity does not reach the filter element 30, the part of the connecting line 31 projecting into the vacuum container 20 is configured as a riser at a distance from the base of the vacuum container 20. A device to generate an overpressure 32 is arranged in the connecting line 31, which is designated as an overpressure device in the following and is configured as a pressure pump, for example. The overpressure device 32 generates an overpressure, which is between 1 and 6 bar, for example. The second container 21 is also designated as an overpressure container.

Because of the overpressure, the pre-cleaned dirty liquid 29 flows via the connecting line 31 out of the vacuum container 20 into the filter element 30. A non-return valve 34, which prevents the pre-cleaned dirty liquid 29 from flowing back into the vacuum container 20, is located in the connecting line 31 in a direction of flow 33 before the overpressure device 32.

Because of the overpressure in the filter element 30, the pre-cleaned dirty liquid 29 flows through the filter element 30 in a direction of flow 35 into the overpressure container 21. Solid matter contained in the pre-cleaned dirty liquid 29 gets deposited on the base of the filter element 30 due to gravity or gets caught in the filter element 30. Recycled cooling and flushing liquid 36 collects in the overpressure container 21, which can be conveyed to the core drill 1 so that the cycle is closed. Due to the pressure difference, the recycled cooling and flushing liquid 36 flows in a direction of flow 37 via a discharge line 38 and the supply line 9 into the core drill 1; the discharge line terminates with one end in the overpressure container 21 and is connected on another end to the outlet port 10 of the processing device 2.

Solid matter from the pre-cleaned dirty liquid 29 gets deposited in the pores of the filter element 30, which reduces the filtration performance of the filter element 30 as the operating life increases. The filter element 30 is replaced regularly in order to ensure an adequate filtration and cleaning of the pre-cleaned dirty liquid 29.

In order to ensure that a used filter element 30 is replaced with a new filter element 30 in a timely manner, the processing device 2 may have a measuring device, which determines for example the flow speed of the recycled cooling and flushing liquid 36 or another suitable measured value, which allows conclusions to be drawn about the efficiency of the filter element 30 to be drawn. If the flow speed falls short of a predetermined, adjustable limit value, a control device issues a corresponding acoustic or optical warning. If the filtration performance of the filter element 30 is no longer sufficient and if an adequate supply of recycled cooling and flushing liquid 36 to the core drill 1 is no longer guaranteed, the control device shuts the processing device 2 off.

To remove a used filter element 30, the operator detaches the cover 23 of the overpressure container 21 when the processing device 2 is shut off. The filter element 30 is removed from the overpressure container 21 and disposed of as hazardous waste. A handle is arranged on the cover of the filter element 30, which allows the filter element 30 to be removed simply and ergonomically from the overpressure container 21. The operator does not come into contact with the solid matter that is located in the interior space of the filter element 30 due to the fact that the interior space of the filter element 30 is not accessible to the operator.

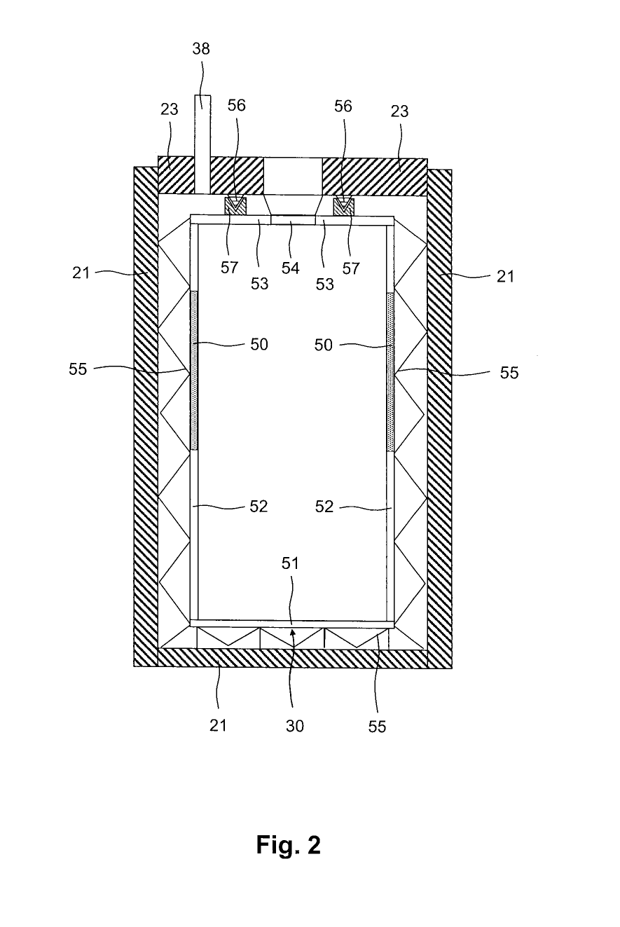

FIG. 2 shows an embodiment of the filter element 30 of the processing device 2 according to the invention that is shown in FIG. 1.

The filter element 30 has a filter surface 50 and is constructed as a cylindrical body made up of a base 51, a lateral area 52, and a cover 53. The filter surface 50 is arranged in the lateral area 52. In the region of the base 51, the lateral area 52 for the pre-cleaned dirty liquid 29 is configured to be impermeable in the region of the base 51. A portion of the solid matter contained in the pre-cleaned dirty liquid 29 gets deposited by sedimentation on the base 51 of the filter element 30. The cover 53 is fastened on the lateral area 52 and has an inlet opening 54 for the pre-cleaned dirty liquid 29.

A holding device 55, which mechanically supports the filter element 30, is provided in the overpressure container 21. In the embodiment in FIG. 2, the holding device 55 is configured as a support element, which is mechanically connected to the overpressure container 21.

Arranged on the cover 23 of the overpressure container 21 is a sealing element 56 on the inner side facing the filter element 30, which sealing element can be brought into engagement in a positive fit with another sealing element 57, which is provided on the cover 53 of the filter element 30.

The size of filter surface 50 is selected such that sufficient recycled cooling and flushing liquid 36 can be conveyed to the power tool, which is configured as a core drill 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for processing a cooling and flushing liquid from a dirty liquid, comprising:
a first container coupled to a suction device;
a second container in fluid communication with the first container and coupled to a pressure device; and
a filter element arranged in the second container, wherein the filter element is arranged in a flow direction before the second container.

2. The device according to claim 1, further comprising a connecting line which connects the first container to the filter element.

3. The device according to claim 1, wherein the filter element is cylindrical with a base, a lateral area, and a cover, wherein a filter surface is provided in the lateral area.

4. The device according to claim 3, wherein the cover is connected to the lateral area.

5. The device according to claim 3, wherein the filter element is a one-piece injection molded part which is insert molded around the filter surface.

6. The device according to claim 1, wherein the filter element is supported on the second container by a holding device.

7. The device according to claim 6, wherein the holding device is a support element which is connected to the second container.

8. The device according to claim 3, wherein the lateral area is impermeable and wherein the filter surface is permeable.
